(19) United States
(12) Patent Application Publication
(10) Pub. No.: US 2006/0163226 A1
(43) Pub. Date: Jul. 27, 2006

(54) Portable welder gun

(76) Inventor: Franco Mela, Piazzola Sul Brenta (IT)

Correspondence Address: Modiano & Associati, Via Meravigli 16, Milano, 20123, IT

(21) Appl. No.: 10/563,113

(22) PCT Filed: Jul. 5, 2004
(86) PCT No.: PCT/EP04/07322

§ 371 Date: Jan. 3, 2006

(30) Foreign Application Priority Data
Jul. 15, 2003 (IT) PD2003U000058

(51) Int. Cl. B23K 9/10

(52) U.S. Cl. 219/130.1

(57) ABSTRACT

A portable welder, comprising a box-like body that contains a welding generator associated with cooling devices, the welding generator being functionally connected to an electrode supporting clamp, to a ground clamp and to an electric power supply system. A handle for gripping and orienting the welder protrudes from the box-like body; the electrode supporting clamp is rigidly coupled to the free end of the handle.

### TECHNICAL FIELD

The present invention relates to a portable welder.

### BACKGROUND ART

Covered-electrode arc welding is a manual welding method that has now been known and used for many years and utilizes the heat generated by an electric arc that forms between a consumable covered electrode and the parts to be welded.

Its widespread use is due to its great operating versatility, particularly to the possibility to provide joints in many welding positions and in any environment (indoors or outdoors).

Currently, the arc welders with covered electrode that are in use are mostly portable and comprise, depending on their size (and therefore their power), a welder body that is associated with the structure of a truck for movement or with the structure of a case.

Such welder body is constituted by a box-like body that contains a welding generator associated with cooling means; the welding generator is functionally connected, by means of connecting cables, to an electrode supporting clamp, to a ground clamp and to an electric power supply system.

A cable thus extends from the welder body and ends on the electrode supporting clamp, which can be handled by the operator in order to arrange the electrode proximate to the welding position, in contact with the part to be welded.

New technologies have allowed, in recent years, to reduce the weight and dimensions (at least for small- and medium-power welders) of the welder bodies, obtaining dimensions that allow to keep them attached to the shoulder of the user by means of shoulder straps.

Although flexibility in the ease of transport and use of such welders has increased considerably in recent years, such welders still have aspects that can be improved.

For example, the welders must still always be “prepared” before welding. It is in fact necessary to connect the connecting cables from the generator to the electrode supporting clamp; once the welding work has ended, the cables are disconnected and stored in an appropriately provided container together with the electrode supporting clamp.

If one considers welders with a truck structure, it is evident that the operating range of the electrode supporting clamp is limited to the length of the cable that connects it to the welder body.

Shoulder-carried portable welders avoid the problem of the operating range of the electrode supporting clamp, but can be awkward because in certain situations they can hinder the movements of the operator.

Moreover, every time it is necessary to change an operating parameter of the welding process, the operator has to use one hand (the other one is busy with the electrode supporting clamp) to operate a switching button provided on the welder body, and it may be important to use said hand for other functions.

### DISCLOSURE OF THE INVENTION

The aim of the present invention is to provide a portable welder that solves the drawbacks noted in known types.

Within this aim, an object of the present invention is to provide a portable welder that is compact and can be used easily by an operator in any working position.

This aim and this and other objects that will become better apparent hereinafter are achieved by a portable welder comprising a box-like body that contains a welding generator associated with cooling means, said welding generator being functionally connected to an electrode supporting clamp, to a ground clamp and to an electric power supply system, said portable welder being characterized in that a handle for gripping and orienting said welder protrudes from said box-like body, said electrode supporting clamp being rigidly coupled to said handle.

### BRIEF DESCRIPTION OF THE DRAWINGS

Further characteristics and advantages of the present invention will become better apparent from the following detailed description of a preferred but not exclusive embodiment thereof, illustrated by way of nonlimiting example in the accompanying drawings, wherein the sole FIGURE is a partially sectional schematic view of the welder according to the invention.

### WAYS OF CARRYING OUT THE INVENTION

With reference to the FIGURE, a portable welder according to the invention is generally designated by the reference numeral 10.

The portable welder 10 comprises a box-like body 11, which contains a welding generator 12 associated with cooling means 13.

The cooling means 13 are constituted for example by a motorized fan 14, which is fixed to the body 11 at an intake 15; a corresponding outlet 15a for the cooling air stream is formed in said body.

A handle 16 designed to allow an operator to grip and orientate the welder cantilevers out from the box-like body 11; in particular, in this embodiment the handle 16 is formed monolithically with the box-like body 11.

An electrode supporting clamp 17 is formed on the free end of the handle 16 and is functionally connected to the welding generator 12 by means of a first coupling 18.

In particular, the electrode supporting clamp 17 comprises a first jaw, which is constituted by the handle 16, and a second jaw (not shown in the FIGURE), which is pivoted to said handle.

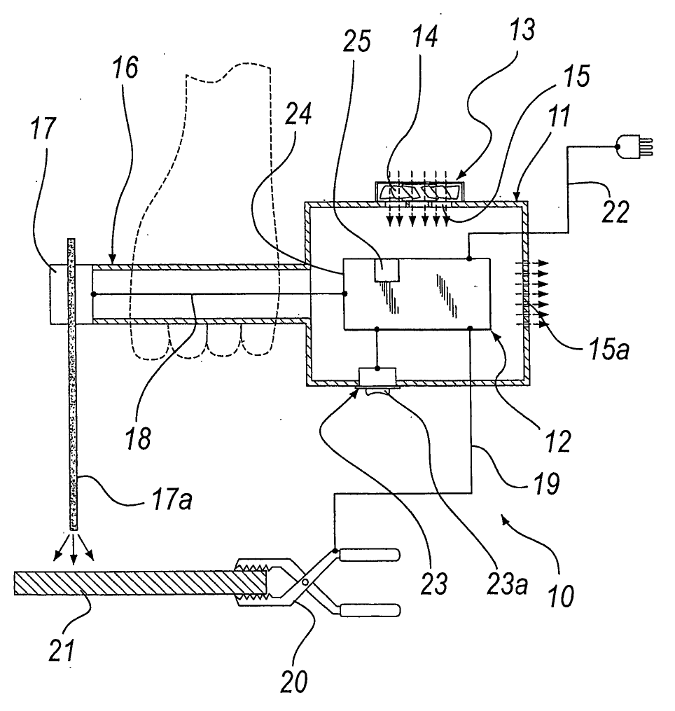

FIG. 1 also illustrates the electrode 17a, locked between the jaws of the clamp 17.

A ground clamp 20 is functionally connected to the welding generator 12 by means of a second coupling 19 that protrudes from the box-like body 11 and is designed to be fixed to the part to be welded, here designated by the reference numeral 21.

A third coupling 22 for connection to the electric power supply grid further extends from the welding generator 12.

A switch 23, such as for example a button 23a for switching the functions of the welder, is also functionally associated with the welding generator 12.

The slider button 23a is arranged externally on the box-like body 11.

Advantageously, in an alternative embodiment not shown in the FIGURE, the switch 23 is arranged externally on the box-like body 11.

The welding generator 12 comprises an insulated AC/DC converter 24, with which an EMC filter 25 is associated; said converter and said filter are both of a type that is known in the field of welders.

The operation of the invention in terms of welding is simple and similar to all other welders.

From the point of view of practicality in work and easy handling, such welder is extremely effective: by holding the handle and the second jaw with a single hand, the electrode supporting clamp 17 is opened and the electrode 17a is inserted; the second jaw is released, while holding tight the handle 16; at this point, the ground clamp 20 is fixed onto the part 21 to be welded.

The entire welder 10 is thus moved by means of the handle 16 in order to arrange the end of the electrode on the welding position.

The welder is switched on by acting on the slider button 23a and the fan 14 starts operating in order to cool the generator 12.

All this occurs while holding the welder with just one hand.

In practice it has been found that the invention thus described solves the problems noted in known types of portable welder; in particular, the present invention provides a portable welder that is particularly compact and allows the entire welder to be held and controlled with a single hand, thus avoiding the external connecting cables between the generator and the electrode supporting clamp and any inconvenience linked to the fact of having the welder far from the welding area.

In practice, the materials employed, so long as they are compatible with the specific use, as well as the dimensions, may be any according to requirements and to the state of the art.

The disclosures in Italian Utility Model Application No. PD2003U000058 from which this application claims priority are incorporated herein by reference.

What is claimed is:

1-8. (canceled)

9. A portable welder, comprising a box-like body that contains a welding generator functionally connected to an electrode supporting clamp, to a ground clamp and to an electric power supply system, a handle for gripping and orienting said welder protruding from said box-like body, said electrode supporting clamp being rigidly coupled to said handle.

10. The welder of claim 9, wherein said handle cantilevers out from said box-like body, said electrode supporting clamp being arranged on the free end of said handle.

11. The welder of claim 9, wherein said electrode supporting clamp comprises a jaw constituted by said handle and a second jaw pivoted to said handle.

12. The welder of claim 9, wherein said welding generator comprises an insulated AC/DC converter associated with an EMC filter.

13. The welder of claim 9, wherein said welding generator is associated with cooling means.

14. The welder of claim 13, wherein said cooling means comprise a motorized fan, which is fixed to said body at an intake, a corresponding outlet for the cooling air stream being formed in said body.

15. The welder of claim 9, wherein a switch for switching the functions of the welder is functionally associated with said welding generator and is arranged externally on said box-like body.

16. The welder of claim 9, wherein a switch for switching the functions of the welder is functionally associated with said welding generator and is arranged externally on said handle.
